(19) United States
(12) Patent Application Publication
(10) Pub. No.: US 2008/0086578 A1
(43) Pub. Date: Apr. 10, 2008

(54) Integrated circuit device having send/receive macro for serial transfer bus

(75) Inventors: Toshikazu Yoshida, Kawasaki (JP); Masaaki Tani, Kawasaki (JP); Kenji Furuya, Kawasaki (JP); Akio Hara, Kawasaki (JP); Tomoki Kurata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,687

(22) Filed: Nov. 20, 2007

Related U.S. Application Data
(62) Division of application No. 10/814,282, filed on Apr. 1, 2004.

(30) Foreign Application Priority Data
Oct. 23, 2003 (JP) 2003-363038

(51) Int. Cl. G06F 3/00

(52) U.S. Cl. 710/48

(57) ABSTRACT

An integrated circuit device having a send/receive macro for serially transferring addresses and data to or from an external device via a serial transfer bus, the integrated circuit device includes: a CPU for performing predetermined processing. The send/receive macro includes a send/receive buffer accessed by the CPU, for storing a plurality of units of data to be transmitted or received over the serial transfer bus; an acknowledge detection unit for detecting a data acknowledge signal transmitted from a receiving device in response to transmission of predetermined units of data; and a data send unit for transmitting data stored in the send/receive buffer, in response to detection of the data acknowledge signal by the acknowledge detection unit, without generating any interrupt to the CPU. And the acknowledge signal detection unit generates a data acknowledge signal non-detection interrupt to the CPU if the acknowledge detection unit does not detect a data acknowledge signal transmitted from the receiving device in response to transmission of the predetermined units of data.

### CROSS-REFERENCE TO RELATED APPLICATIONS

This application is based upon and claims the benefit of priority from the prior Japanese Patent Application No. 2003-363038, filed on Oct. 23, 2003, the entire contents of which are incorporated herein by reference.

### BACKGROUND OF THE INVENTION

1. Field of the Invention

The present invention relates generally to an integrated circuit device having a send/receive macro for a serial transfer bus, and more particularly to a send/receive macro incorporating a send/receive buffer and capable of reducing CPU load by reducing the frequency of interrupts to the CPU during send or receive processing.

2. Description of the Related Arts

Microcomputers incorporate a timer, AD converter, send/receive macro for serial transfer bus and so on as resources together with CPU, programmed ROM, RAM and external bus interface. External bus interface has interfacing capability with multi-bit external bus such as 32-bit bus, whereas send/receive macro for serial transfer bus has interfacing capability with serial transfer bus consisting of a single data line and a single clock line.

The I2C Standard proposed by Philips (refer, for example, to Japanese Patent Application Laid-open Pub. No. 2000-242573) is among the serial transfer bus. The I2C Standard serial transfer bus serially transfers addresses and data via a single data line in synchronization with clock. According to the Standard, a send/receive macro on the master side transmits start and stop conditions to the slave side using two bits comprised of the clock and data, and the send/receive macro on the sending side serially transfers addresses or data in synchronization with clock after the start condition is assumed. Each time one-byte data is transferred, the send/receive macro on the receiving side returns an acknowledge signal through the data line. Therefore, the send/receive macros on the sending and receiving sides must generate interrupts to the CPU to send and check the acknowledge signal at each data transfer.

Designed for applications such as setting predetermined data through data transfer between LSIs at the power-on or start of a predetermined processing session, such a serial transfer bus is widely used to implement data transfer by effectively using limited bus hardware resources.

### SUMMARY OF THE INVENTION

According to a first aspect of the present invention there is provided an integrated circuit device having a send/receive macro for serially transferring addresses and data to or from an external device via a serial transfer bus, the integrated circuit device comprising: a CPU for performing predetermined processing, wherein the send/receive macro comprises a send/receive buffer accessed by the CPU, for storing a plurality of units of data to be transmitted or received over the serial transfer bus; an acknowledge detection unit for detecting a data acknowledge signal transmitted from a receiving device in response to transmission of predetermined units of data; and a data send unit for transmitting data stored in the send/receive buffer, in response to detection of the data acknowledge signal by the acknowledge detection unit, without generating any interrupt to the CPU, and wherein the acknowledge signal detection unit generates a data acknowledge signal non-detection interrupt to the CPU if the acknowledge detection unit does not detect a data acknowledge signal transmitted from the receiving device in response to transmission of the predetermined units of data.

According to a second aspect of the present invention there is provided an integrated circuit device having a send/receive macro for serially transferring addresses and data to or from an external device via a serial transfer bus, the integrated circuit device comprising: a CPU for performing predetermined processing, wherein the send/receive macro comprises a send/receive buffer accessed by the CPU, for storing a plurality of units of data to be transmitted or received over the serial transfer bus; a data send unit for transmitting data stored in the send/receive buffer; and an arbitration lost detection unit for detecting whether or not, during an address phase in which the data send unit functioning as a master serially transmits an address identifying a slave device, an arbitration lost is occurred as a result of concurrent transmission of an address from other master, and wherein when the arbitration lost detection unit does not detect occurrence of the arbitration lost during the address phase, the CPU stores data to be transmitted in the send/receive buffer after the address phase.

According to a third aspect of the present invention there is provided an integrated circuit device having a send/receive macro for serially transferring addresses and data to or from external devices via a serial transfer bus, the integrated circuit device comprising a CPU for performing predetermined processing, wherein the send/receive macro comprises a send/receive buffer accessed by the CPU, for storing a plurality of units of data to be transmitted or received over the serial transfer bus; a data receive unit for receiving data transmitted via the serial transfer bus and storing the received data in the send/receive buffer; and an acknowledge signal generation unit for transmitting a data acknowledge signal to a sending device in response to reception of the predetermined units of data, and wherein the acknowledge signal generation unit transmits the data acknowledge signal on each reception of the predetermined units of data until reaching to a receivable data unit count without generating any interrupt to the CPU, and the acknowledge signal generation unit stops transmission of the data acknowledge signal when reaching to the receivable data unit count.

According to a fourth aspect of the present invention there is provided an integrated circuit device having a send/receive macro for serially transferring addresses and data to or from external devices via a serial transfer bus, the integrated circuit device comprising: a CPU for performing predetermined processing, wherein the send/receive macro comprises a send/receive buffer accessed by the CPU, for storing a plurality of units of data to be transmitted or received over the serial transfer bus; a data send/receive unit for receiving data transmitted via the serial transfer bus and storing the received data in the send/receive buffer, and for transmitting the data stored in the send/receive buffer; and an access flag register for storing, in the event of an access from the CPU to the send/receive buffer during transmission and reception the of transferring data by the data send/receive unit, a flag indicating occurrence of the access.

According to the first aspect, when sending data, the send/receive macro can continuously send a plurality of units of data without generating any interrupt to the CPU until the macro no longer receives data acknowledge from the receiving side, reducing load on the CPU and allowing serial transfer of a large amount of data.

According to the second aspect, the send/receive macro stores transmission data in a send/receive buffer after checking bus arbitration during the address phase and confirming that no arbitration lost has occurred during the address phase, preventing waste of transmission data stored in the send/receive buffer due to arbitration lost.

According to the third aspect, when receiving data, the send/receive macro can continuously receive a plurality of units of data without generating any interrupt to the CPU until the predetermined data unit count is reached, reducing load on the CPU and allowing serial transfer of a large amount of data.

According to the fourth aspect, an access flag register is provided to store CPU accesses to the send/receive buffer erroneously made during data transfer, allowing software debugging step to be efficiently performed by using the access flag register.

### BRIEF DESCRIPTION OF THE DRAWINGS

The above and other aspects, features and advantages of the present invention will become more apparent from the following detailed description when taken in conjunction with the accompanying drawings, in which:

FIG. 1 illustrates a serial transfer bus in the present embodiment;

FIG. 2 is an overall configuration diagram of a microcomputer that serves as an integrated circuit apparatus in the present embodiment;

FIG. 3 is a configuration diagram of a send/receive macro in the present embodiment;

FIG. 4 illustrates an example of a drive circuit of a serial transfer bus;

FIG. 5 is a signal waveform diagram of the serial transfer bus;

FIG. 6 is a timing chart describing a first embodiment;

FIGS. 7(A) and 7(B) are explanatory views describing a bus arbitration procedure;

FIG. 8 is an operational flowchart of the send/receive macro in the present embodiment;

FIG. 9 is a sequence chart of the present embodiment;

FIG. 10 is another sequence chart of the present embodiment;

FIG. 11 illustrates a partial configuration of the send/receive macro in the present embodiment; and

FIG. 12 is a sequence chart of the present embodiment.

### DESCRIPTION OF THE PREFERRED EMBODIMENTS

Conventional serial transfer buses does not generate interrupts to the CPU so often because the transfer data volume is not very large, putting only a not-so-significant load on the CPU. However, with ever-increasing transfer data volumes in recent years, the send/receive control method, in which an interrupt is generated to the CPU on every transfer of one-byte data as is done by conventional send/receive macros, is not preferred due to upsurge in CPU load.

In light of the foregoing, it is an object of the present invention to provide an integrated circuit device having a send/receive macro for a serial transfer bus capable of enhancing transfer data volumes without producing a larger CPU load.

Embodiments of the present invention will now be described with reference to the accompanying drawings. It is to be understood that the technical scope of the present invention is not limited to those embodiments and is intended to cover matters defined in the appended claims and equivalents thereof.

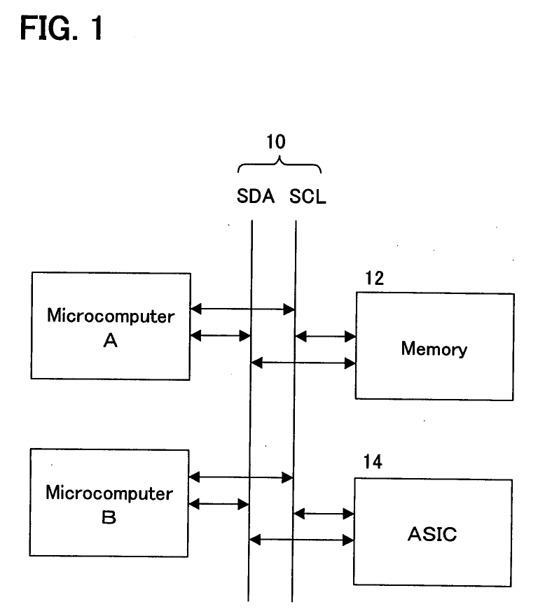

FIG. 1 illustrates a serial transfer bus in an embodiment of the present invention. A serial transfer bus 10 consists of a single data line SDA and a single clock line SCL. In other words, a single-channel serial transfer bus is constituted by a pair of buses made up of data and clock lines. If there are a plurality of channels, therefore, a plurality of pairs of buses are provided, each made up of the data and clock lines SDA and SCL. In FIG. 1, microcomputers A and B, a memory 12 and a functional device 14 having the predetermined capability are connected to one another via the bus 10. Thus, the serial transfer bus in the present embodiment connects a plurality of devices (integrated circuit devices) together, serially transferring data over a single data line in synchronization with clock.

A send/receive macro for transferring data via the serial transfer bus 10 is incorporated in the microcomputers A and B, the memory 12 and the functional device 14. The send/receive macro has interfacing capability with the serial transfer bus 10.

When writing data to other device such as the memory 12, the microcomputer A functions as master and sends onto the bus an address identifying the memory 12 that functions as slave. When an acknowledge is returned from the memory 12 in response thereto, the microcomputer A acts as sender and transfers data to the memory 12 that acts as receiver. Secondly, when reading data from other device such as the microcomputer B or the functional device 14, the microcomputer A functions as master and transfers an address identifying the device that functions as slave. When an acknowledge is returned from the slave device in response thereto, the microcomputer A acts as receiver and receives data transmitted from the device that acts as sender.

The aforementioned data transfer is carried out, for instance, at the system power-on or on every predetermined session or phase, and data transfer occurs from the microcomputer A to other device in some cases and from other device to the microcomputer A in other cases.

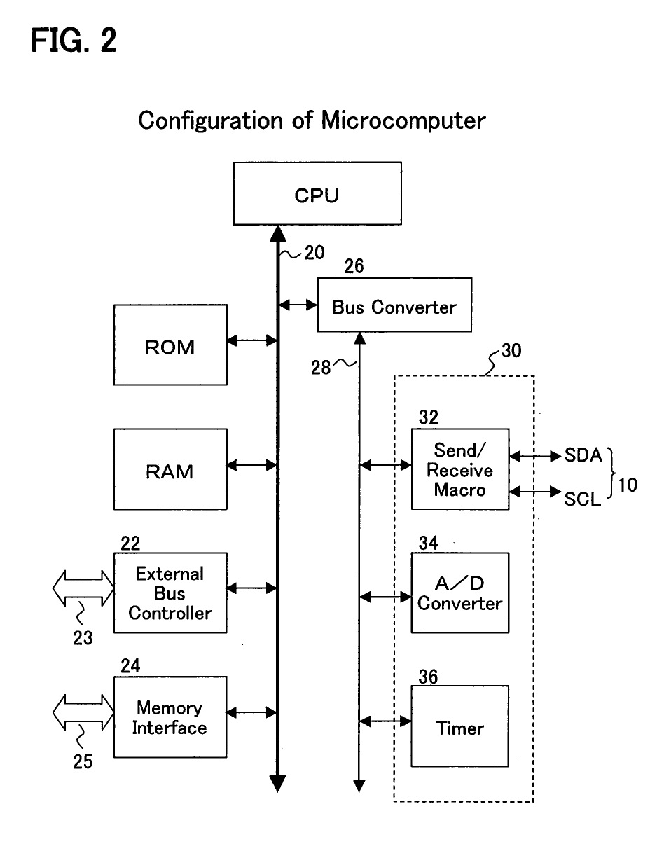

FIG. 2 illustrates an overall configuration diagram of a microcomputer that serves as integrated circuit device in the present embodiment. The microcomputer includes a CPU that performs predetermined processing, a ROM that stores programs run by the CPU, a RAM in which the CPU temporarily stores data during processing, an external bus controller 22 that interfaces to an external bus 23 and a memory interface 24 that handles interfacing between a bus 25 and external memory which are connected to one another via a high-speed CPU bus 20. The microcomputer also has a send/receive macro 32 that handles interfacing with the serial transfer bus 10, an AD converter 34, a timer 36, etc. as peripheral resources 30 that are connected to one another via a low-speed bus 28. On the other hand, the low-speed bus 28 is connected to the high-speed CPU bus 20 via a bus converter 26. The CPU bus 20 is, for example, 32-bit wide, and the low-speed bus 28 is less wide, for example, 16-bit wide.

The external bus controller 22 and the memory interface 24, each connected to the high-speed bus 20, operate in synchronization with high-speed clock, whereas the send/receive macro 32 connected to the low-speed bus 28 operates in synchronization with low-speed clock.

The CPU performs predetermined processing by running programs in the ROM. When transferring data via the serial transfer bus 10, the CPU carries out data transfer by controlling the send/receive macro 32. In the present embodiment, a send/receive buffer constituted by FIFO is provided, for example, in the send/receive macro 32 to increase transfer data volumes, thus allowing the send/receive macro 32 to conduct serial data transfer without often generating interrupts to the CPU once the CPU stores data in the buffer and instructs that data be transferred. It is to be noted that the send/receive macro 32 has various improved configurations for reduced frequency of interrupts to the CPU in order to adapt to the characteristics specific to the serial transfer bus 10.

### First Embodiment

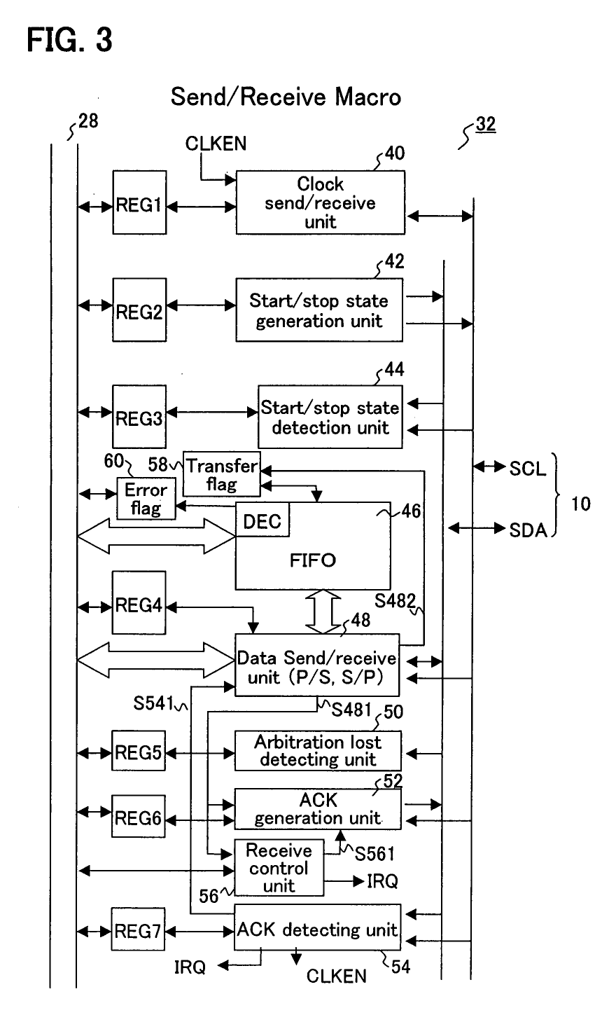

FIG. 3 illustrates a configuration diagram of the send/receive macro in the present embodiment. To increase data transfer volume, the send/receive macro 32 has a FIFO 46 as a send/receive buffer for storing a plurality of pieces of transmitting data and received data and is configured so as to be accessible from the CPU via the low-speed bus 28. The send/receive macro 32 also has a data send/receive unit 48 as means for sending/receiving addresses and data, and the CPU instructs the unit 48 via a register REG4 to transmit or receive data. When sending data, the data send/receive unit 48 converts parallel data in the FIFO 46 to serial data and sends the data serially onto the bus 10. When receiving data, the data send/receive unit 48 converts serial data received serially from the bus 10 to parallel data and stores the received data in the FIFO 46. Serial data transfer is carried out one bit at a time in synchronization with clock output onto the clock line SCL. Address or data is, in some cases, directly set in the data send/receive unit 48 by the CPU via the low-speed bus 28.

The send/receive macro 32 has a clock send/receive unit 40 for sending synchronous transfer clock onto or receiving it from the clock line SCL of the serial transfer bus 10, generating and sending or receiving a clock adapted to the clock speed which is specified and stored in a register REG1 by the CPU. A start/stop condition generation unit 42 generates start and stop conditions for data transfer according to two signals of data signal SDA and clock signal SCL and sends these conditions. When the send/receive macro 32 is in master mode, the start/stop condition generation unit 42 drives the bus 10 to data transfer start condition and the data send/receive unit 48 serially sends an address identifying the slave device. Then, the master and slave sides transfer data between them (data is read from or written to the slave device). To end data transfer, the start/stop condition generation unit 42 outputs data transfer stop condition. When initiating another data transfer, the start/stop condition generation unit 42 outputs data transfer start condition once again. The start/stop condition generation unit 42 drives the bus 10 to one of the states in response to the instruction set in a register REG2 from the CPU.

A start/stop condition detection unit 44 detects the start or stop condition output to the serial transfer bus 10. Then, an address transferred after the start condition is assumed is checked to determine whether the address corresponds to its own address. The start/stop condition detection unit 44 stores the detected state data in a register REG3 and notifies the CPU of the state.

According to the start/stop condition generation unit 42 and the start/stop condition detection unit 44, it is possible to monitor whether data or address transfer to the serial transfer bus 10 is in progress. For this reason, a transfer-in-progress flag register 58 is provided. When data transfer is in progress, a transfer-in-progress flag is written to the transfer-in-progress flag register 58 based on a data transfer start signal S482 from the data send/receive unit 48.

In master mode, an arbitration lost detection unit 50 detects whether or not, during the address phase in which an address is serially output from the data send/receive unit 48, whether the bus right is lost in the arbitration procedure for bus right acquisition after an address conflicting with the address is concurrently output from other device. The arbitration procedure will be described in detail later. Occurrence of the arbitration lost is notified to the CPU via a register REG5.

An acknowledge generation unit or ACK generation unit 52 outputs an acknowledge signal onto the data line SDA, for example, to inform the sending device that one-byte data has been successfully received in the data phase after receipt of the data. The output of acknowledge signal is carried out without generating any interrupt to the CPU as described later. Alternatively, the ACK generation unit 52 also outputs an acknowledge signal onto the data line SDA to inform the master device of address match when the received address corresponds to its own address in the address phase. The instruction for acknowledge signal output is issued from the CPU via a register REG6.

An acknowledge detection unit or ACK detection unit 54 detects an acknowledge signal transmitted from the slave device in the address phase and an acknowledge signal transmitted from the receiving device in the data phase. The ACK detection unit 54 generates a non-detection interrupt signal IRQ to the CPU as a result of detection of non-reception of acknowledge signal in the data phase, causing the clock send/receive unit 40 to drive the clock line SCL to L level according to a clock enable signal CLKEN, putting the bus into wait state and preventing next data from being transferred.

A receive control unit 56 is set to a receive data count by the CPU as described later. When the receive control unit 56 continuously receives as much data as the set receive data count, the receive control unit generates an interrupt IRQ to the CPU, and the ACK generation unit 52 allows (or prohibits) a generation of acknowledge signal according to the state of an acknowledge signal send enable flag (not shown).

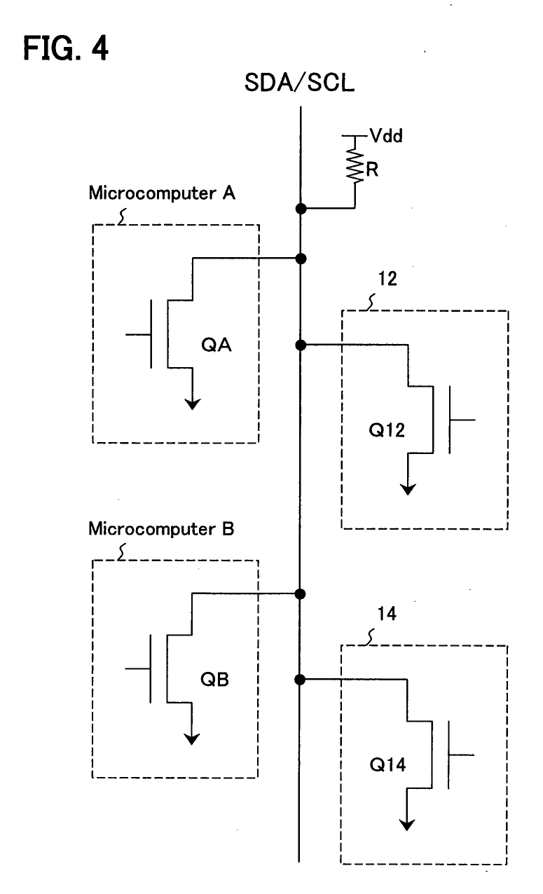

FIG. 4 illustrates an example of a drive circuit of the serial transfer bus. In FIG. 4, drive circuits are shown for the four devices shown in FIG. 1. The drive circuits for the respective devices are constituted by open-drain transistors QA, QB, Q12 and Q14 in which the drain terminal is connected to the data line SDA (or clock line SCL) of the serial transfer bus, with the source grounded. The data line SDA (or clock line SCL) is connected to a power supply Vdd via a pull-up resistor R. Therefore, if none of the drive transistors is driven, the bus data line SDA (or clock line SCL) is maintained in H level. On the other hand, if any of the drive transistors is driven, the bus data line SDA (or clock line SCL) is brought down to L level. Such drive circuits are provided in the clock send/receive unit 40, the start/stop condition generation unit 42, the data send/receive unit 48 and the ACK generation unit 52.

The send/receive macro for each of the devices is provided with a voltage level detection circuit for the bus data line SDA (or clock line SCL), thus detecting the bus voltage as being in H or L level. Such a detection circuit is provided in the clock send/receive unit 40, the start/stop condition detection unit 44, the data send/receive unit 48, the arbitration lost detection unit 50, the ACK detection unit 54 and so on.

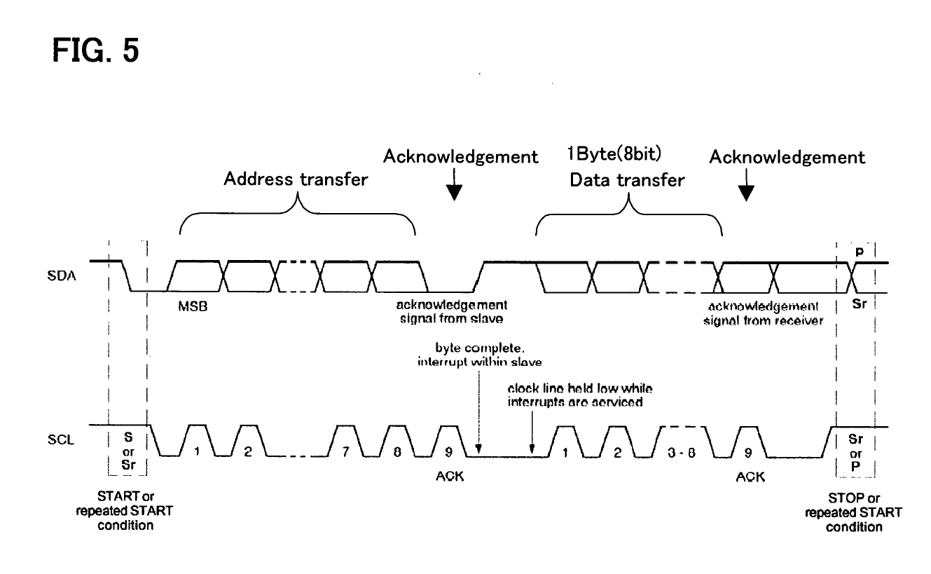

FIG. 5 illustrates a signal waveform diagram of the serial transfer bus. FIG. 5 is diverted from the I2C Standard Bus Specifications. The signal waveforms of the data and clock lines SDA and SCL are shown in FIG. 5. In master mode, the start/stop condition generation unit 42 of the send/receive macro drives the data line SDA from H level to L level while maintaining the clock line SCL in H level, notifying the bus that the start condition is assumed. Next, the send/receive macro on the master side drives the clock line SCL to L level first and then pulls the data line SDA to H or L level, and when driving the clock line SCL from L level to H level, the macro maintains the condition of the data line SDA and causes the slave side to recognize the address signal. Similarly, one-byte address is serially output in synchronization with the clock SCL. The one-byte address contains a read or write operation command. This is the address phase of address transfer.

When a one-byte address is output, the send/receive macro on the slave side identified by the address drives the data line SDA to L level in synchronization with the ninth clock as acknowledge signal. According to the open-drain drive circuits shown in FIG. 4, other devices not identified by addresses maintain the data line SDA in H level, so that a L-level acknowledge signal driven by the address-identified device on the slave side can be transferred to the master side properly.

The address phase is completed by the acknowledge signal from the slave side. Then, the data phase is initiated, and one-byte data is serially output from the transmitting device in synchronization with the clock signal SCL from the master side so as to transfer data. If the operation command is for reading data, the slave side acts as sender, whereas on the other hand, if the operation command is for writing data, the master side acts as sender. Then, when one-byte (eight-bit) data is serially transferred, the receiving side sends a L-level acknowledge signal to the data line SDA. When the receiving side sends the L-level acknowledge signal, the send/receive macro on the sending side continues, in response thereto, the serial transfer of necessary data. If the receiving side does not drive the data line SDA to L level, this means that no acknowledge signal has been sent. This notifies the sending device that the data transfer should be terminated. Then, the device on the master side judges whether to end the data phase.

At the completion of all data transfer, the send/receive macro on the master side drives the data line SDA from L level to H level while maintaining the clock line SCL in H level, thus outputting stop condition. The master mode ends when the stop condition is output. Alternatively, the send/receive macro on the master side may, at the completion of all data transfer, drive the data line SDA from H level to L level while maintaining the clock line SCL in H level, thus outputting start condition once again. In this case, the device on the master side initiates other data transfer while maintaining the master mode.

Thus, acknowledge signal is transmitted from the slave side after transfer of a one-byte address, and acknowledge signal is transmitted from the receiving side after transfer of one-byte data. The master or sending side detects such acknowledge signals and carries out next data transfer. Master mode is maintained from output of start condition to output of stop condition. It is to be noted that the operation for arbitration procedure for bus right acquisition, conducted during address transfer, will be described later.

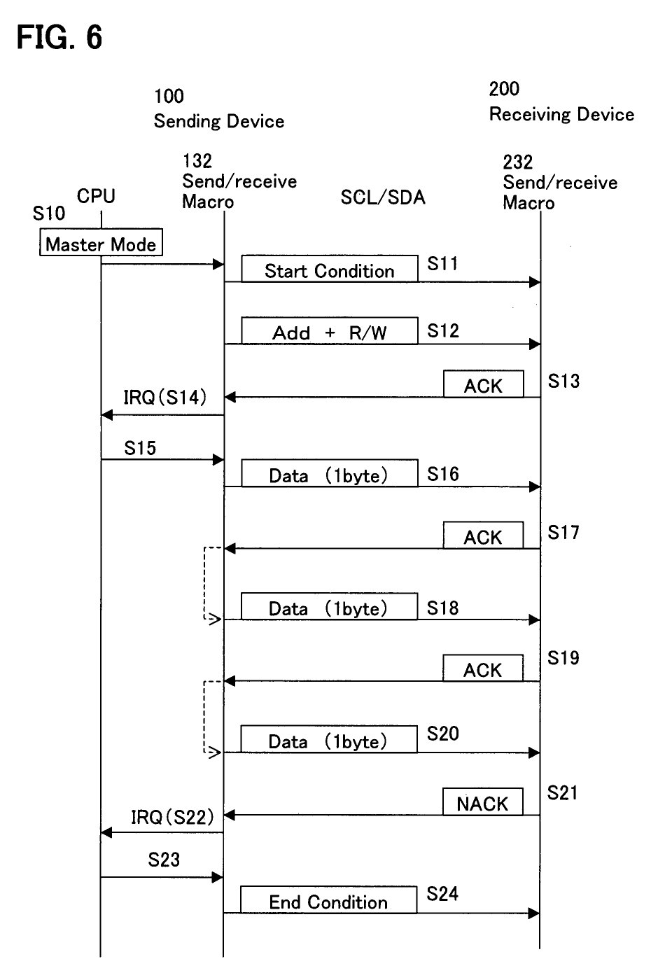

FIG. 6 illustrates a timing chart describing a first embodiment. In the present embodiment, a send/receive buffer constituted by FIFO is provided in the send/receive macro, with the CPU storing multi-byte data in the send/receive buffer, thus enhancing data transfer volumes. Nevertheless, as far as the standard of the serial transfer bus is concerned, the receiving side transmits a data acknowledge signal on every transfer of one-byte data, and the sending side confirms the data acknowledge signal and further serially transfer next one-byte data. If the receiving side does not send any data acknowledge signal, the sending side will not transfer any more data. Thus, in the case of multi-byte data transfer, transmission and confirmation of data acknowledge signal is necessary on every transfer of one-byte data. Generation of an interrupt to the CPU at every occasion of transmission and confirmation will produce a higher CPU load, which is not in line with the object of enhancing data transfer volumes by providing FIFO.

In the present embodiment, for this reason, a one-byte address is serially transferred and acknowledge signal in response thereto is confirmed in the address phase. Then, in the data phase later, when the send/receive macro confirms data acknowledge signal from the receiving side, next one-byte data is serially transferred without generating any interrupt to the CPU. Interrupt is generated to the CPU only if data acknowledge signal cannot be confirmed, thus terminating the data phase.

The operation will be described more specifically in accordance with FIG. 6. The timing chart illustrates an example in which the master side acts as sender while the slave side acts as receiver and data transfer is carried out between a sending device 100 and a receiving device 200. Data transfer takes place between a send/receive macro 132 of the sending device 100 and a send/receive macro 232 of the receiving device 200.

The sending device 100 goes into master mode first (S10), causing the start/stop condition generation unit 42 of the sending send/receive macro 132 to drive the bus to start condition in response to the instruction from the CPU (S11). Thereafter, the sending send/receive macro 132 sends one-byte address (S12), causing the send/receive macro 232 of the device identified by the address on the slave side to output an address acknowledge signal (S13). Upon detection of the address acknowledge signal, the send/receive macro 132 generates an interrupt to the CPU (S14), causing the CPU to instruct data transfer in response thereto (S15).

The sending send/receive macro 132 enters into the data phase, and serially transfers one-byte data stored in the FIFO (S16). As a result of serial transfer of one-byte data, the receiving send/receive macro 232 sends a data acknowledge signal (S17). Upon detection of the data acknowledge signal, the ACK detection unit 54 in the sending send/receive macro 132 instructs the data send/receive unit 48 to transfer next data using an acknowledge detection signal S541 without generating any interrupt to the CPU. In response thereto, the data send/receive unit 48 reads next one-byte data from the FIFO, converts the data from parallel to serial and conducts serial transfer over the bus (S18). As a result of one-byte data transfer, the receiving send/receive macro 232 sends a data acknowledge signal again (S19). Similarly, as described above, upon detection of the data acknowledge signal, the ACK detection unit 54 of the sending send/receive macro 132 instructs the data send/receive unit 48 to transfer next data without generating any interrupt to the CPU. In response thereto, next one-byte data is read from the FIFO and serially transferred (S20).

In the example shown in FIG. 6, at the completion of transfer of three bytes of data, the receiving send/receive macro 132 notifies the sending macro that data transfer should be terminated without sending any data acknowledge signal (S21). Upon detection of non-transmission of data acknowledge signal, the ACK detection unit 54 of the sending macro 132 generates to the CPU an interrupt signal IRQ indicating failure to confirm data acknowledge signal and disables the clock enable signal CLKEN to the clock send/receive unit 40, causing the clock send/receive unit 40 to drive the clock signal line SCL to L level and putting the bus into wait state. This stops signal transmission thereafter and prevents transfer of next data (S22). In response to the interrupt signal IRQ indicating failure to confirm data acknowledge signal, the CPU recognizes the end of the data phase and, when terminating data transfer, instructs the send/receive macro 132 to drive the bus to stop condition. In response thereto, the start/stop condition generation unit 42 of the send/receive macro 132 drives the bus to stop condition (S23). This completes data transfer. Alternatively, the CPU may, in response to the interrupt signal, instruct the start/stop condition generation unit 42 of the send/receive macro to generate start condition again, thus initiating transfer of other data. In this case, the steps from S11 onward in the figure will be repeated.

As described above in the present embodiment, when multi-byte data in the FIFO is transferred in the data phase, the send/receive macro 132 automatically carries out transfer of next one-byte data upon detection of data acknowledge signal following one-byte data transfer, without generating any interrupt to the CPU. Then, the send/receive macro 132 generates an interrupt to the CPU for the first time when no data acknowledge signal is detected, notifying the CPU of termination of the data phase. This ensures reduced frequency of interrupts to the CPU even in the case of continuous transfer of multi-byte data, thus reducing strain on the CPU.

### Second Embodiment

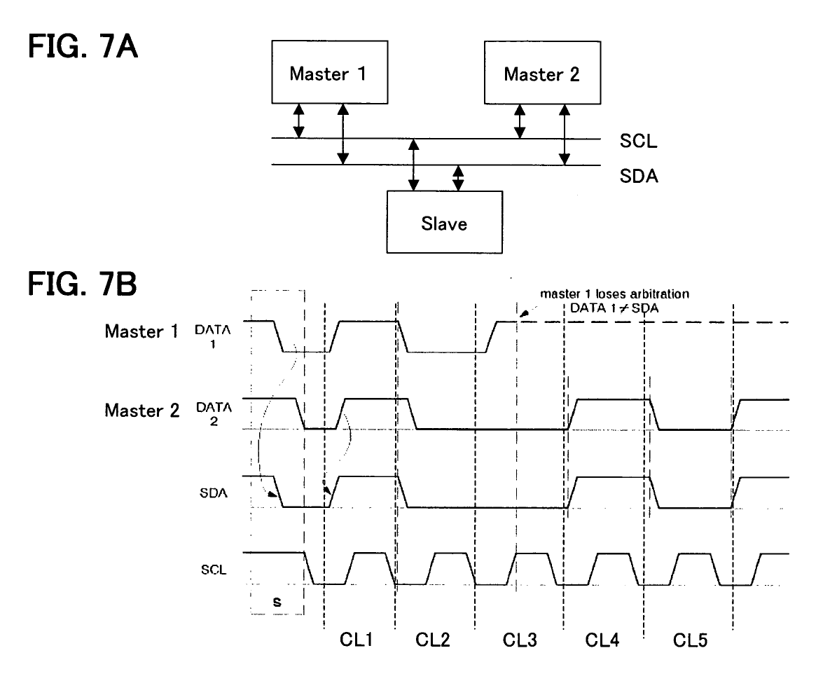

FIGS. 7A and 7B illustrate explanatory views describing the bus arbitration procedure. The figures are diverted from the I2C Standard Bus Specifications. As shown in FIG. 7A, the serial transfer bus in the present embodiment connects a plurality of master and slave devices. In the embodiment, any of the master devices is permitted to drive the bus to start condition at an arbitrary timing for transmitting an address. As a result, the master device that drives the bus to start condition first normally acquires the bus right. However, the plurality of master devices drive the bus to start condition in some rare cases.

The waveform diagram of FIG. 7B shows an example in which masters 1 and 2 drive the bus simultaneously to start condition and start transmitting an address at the same timing. As described in FIG. 4, since the drive circuits are constituted by open-drain transistors, once driven in this way by one of the devices, the bus is driven to L level irrespective of the driving state of the other device.

In the example of FIG. 7B, while the masters 1 and 2 drive identical address signals H and L at clocks CL1 and CL2, the master 1 drives H-level signal and the master 2 L-level signal at clock CL3, resulting in a conflict between the two addresses. As a result, the arbitration lost detection unit 50 in the send/receive macro of the master 1 detects loss of the bus right in the bus arbitration procedure, notifying the CPU of arbitration lost via the register REG5. In response thereto, the CPU stops execution of data transfer in the later data phase.

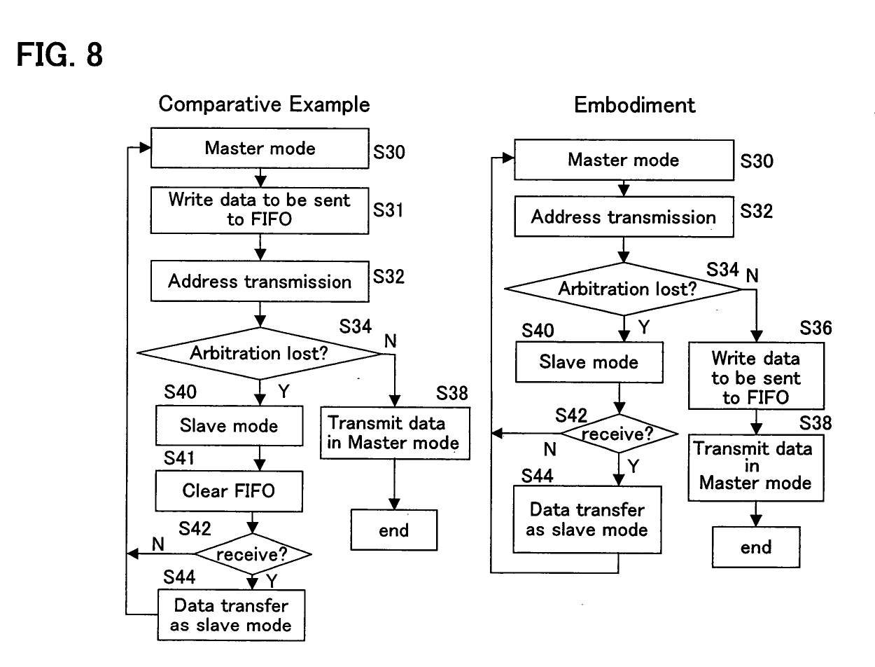

FIG. 8 illustrates a flowchart of the send/receive macro in the present embodiment. The right side of the figure shows the operation in the present embodiment whereas the left side thereof shows the operation in a comparative example. In the present embodiment, the CPU moves into master mode (S30), allowing the send/receive macro to start address transmission (S32). When the send/receive macro does not detect the aforementioned arbitration lost during the address phase (S34), the bus right is assumed to have been validly acquired, allowing the CPU thereafter to write data to be sent to the FIFO (S36). Following data write, multi-byte data is transferred in master mode (S38). If the arbitration lost is detected during the address phase (S34), the send/receive macro moves into slave mode (S40). When an address is received from any one of the master devices (S42), data is transferred in slave mode (S44). Then, the send/receive macro is switched to master mode as appropriate (S30), performing the necessary data transfer steps again.

By contrast with the operation of the present embodiment, in the comparative example, when the send/receive macro moves into master mode (S30), the CPU writes transmission data to the FIFO of the send/receive macro (S31). Then, the send/receive macro sends an address (S32) and checks for any arbitration lost. If an arbitration lost is detected (S34), the send/receive macro moves into slave mode to be in standby (S40), clearing transmission data written in the FIFO (S41). When the send/receive macro receives an address (S42), the macro carries out data transfer in slave mode. The same steps as above are performed when no arbitration lost is detected.

Thus, in the comparative example, transfer data is written to the FIFO before the presence/absence of arbitration lost is checked in the address phase, resulting in waste of the write procedure of the transfer data in FIFO if an arbitration lost is detected. By contrast, in the present embodiment, the arbitration procedure for bus right acquisition is conducted during serial transfer of address in the serial transfer bus, the transfer data is written to the FIFO after confirming the bus right acquisition. This prevents waste of the write procedure of the transfer data to the FIFO.

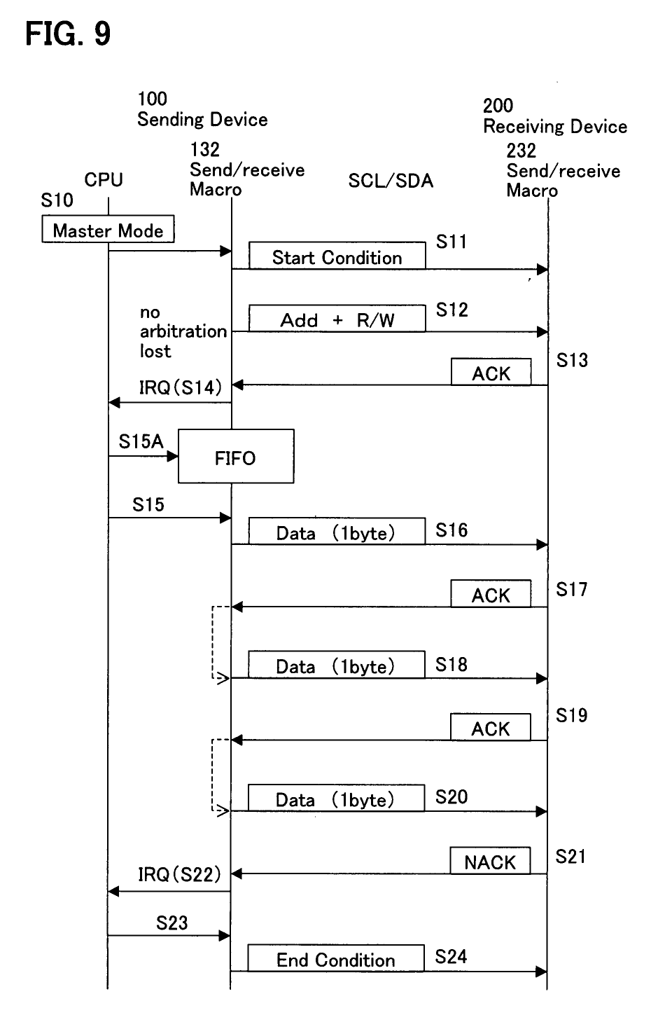

FIG. 9 illustrates a sequence chart of the present embodiment. The same step numbers are assigned to the steps identical to those in FIG. 6. This example shows a case in which no arbitration lost takes place in the address phase. The sending device 100 moves into master mode (S10), causing the send/receive macro 132 to drive the bus to start condition (S11) and then serially transmit a slave address in the address phase (S12). When the send/receive macro 132 properly receives an acknowledge signal from the slave device (S13) due to the fact that no arbitration lost has occurred during the address phase, the macro generates the interrupt IRQ to the CPU (S14), causing the CPU in response thereto to write transfer data to the FIFO in the macro for the first time (S15A). Then, in response to the data transfer instruction from the CPU (S15), the send/receive macro 132 serially transfers the one-byte data in the FIFO (S16). The operation from here onward is the same as that in FIG. 6, that is, at each completion of one-byte data transfer, the macro receives a data acknowledge signal from the receiving side and serially transfers next one-byte data without generating any interrupt to the CPU. The series of data transfer steps are continued until the macro no longer receives data acknowledge signal from the receiving side.

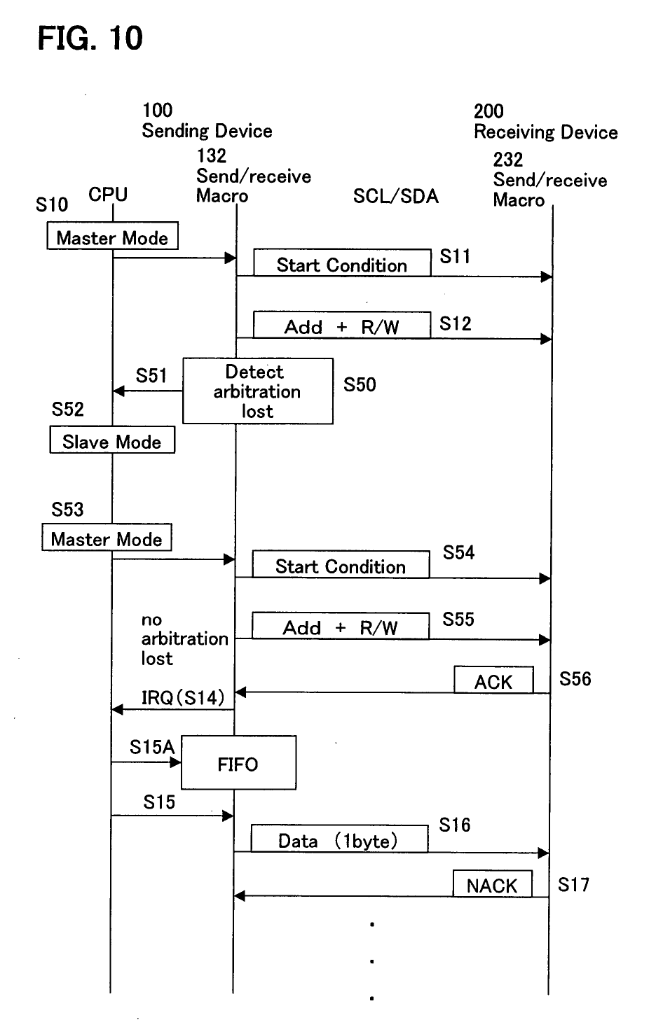

FIG. 10 illustrates another sequence chart of the present embodiment. The same step numbers are also assigned to the steps identical to those in FIGS. 6 and 9. This example shows a case in which arbitration lost takes place during the address phase. After the sending device 100 moves into master mode (S10), the send/receive macro 132 drives the bus to start condition in response to the instruction from the CPU (S11), serially transferring a one-byte address (S12). If the arbitration lost detection unit 50 in the send/receive macro 132 detects an occurrence of arbitration lost during the address phase (S50), the CPU is notified thereof (S51), putting the CPU to slave mode to be in standby (S52). If no slave address is received within a predetermined time period, the CPU moves into master mode again (S53), instructing the send/receive macro 132 to conduct address transfer again in the address phase. In response thereto, the send/receive macro 132 drives the bus to start condition (S54) and then serially transfers a one-byte address (S55). Since no arbitration lost occurs this time during the address phase, the CPU writes transfer data to the FIFO (S15A). The operation from here onward is the same as that in FIG. 9.

Thus, in the present embodiment, transfer data is not written to the FIFO, preventing waste of the data in the FIFO even if arbitration lost occurs during the address phase.

### Third Embodiment

Since a FIFO is provided in the send/receive macro as send/receive buffer capable of storing multi-byte data, the send/receive macro can continuously transfer multi-byte data. In the aforementioned embodiment, a description was made of continuous data transfer by the sending macro without generating any interrupt to the CPU. The third embodiment relates to continuous data reception by the receiving macro without generating any interrupt to the CPU.

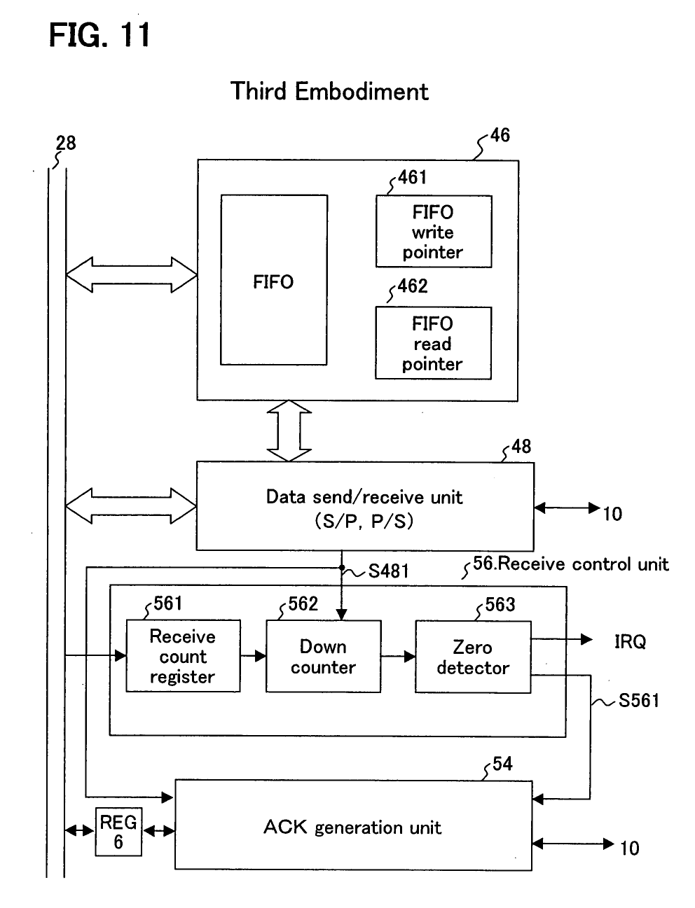

FIG. 11 illustrates a partial configuration of the send/receive macro in the present embodiment. The send/receive buffer 46 has a FIFO and write and read pointers 461 and 462 for controlling the FIFO. The write pointer stores an address to be newly written to in the FIFO whereas the read pointer an address to be newly read from in the FIFO. The receive control unit 56 has a receive count register 561, a downcounter 562 and a zero detection circuit 563.

The CPU sets a receivable byte count in the receive count register 561 prior to start of data reception and enables an acknowledge signal generation enable/disable flag in the register REG6 of the ACK detection unit 54. The set receivable byte count is stored in the downcounter 562, the data send/receive unit 48 output a receive completion signal S481 upon each successful reception of one-byte data, and the downcounter 562 count down the set count. In response to the receive completion signal S481, the ACK detection unit 54 generates a data acknowledge signal and outputs the signal onto the transfer bus 10. When as much data as the receivable byte count is received, the count value in the downcounter 562 reaches zero, which is detected by the zero detection circuit 563 that then generates the interrupt IRQ to the CPU and outputs a count zero signal S561 to the ACK detection unit 54. In response to the count zero signal S561, the ACK detection unit 54 confirms that the data acknowledge signal generation enable/disable flag is enabled and generates no data acknowledge signal, causing no data acknowledge signal to be sent to the sending device. Therefore, the sending device carries out no data transfer from that point.

Thus, the CPU sets, each time it initiates a receive session, a continuous receivable byte count in the receive register 561 and enables or disables the data acknowledge signal generation enable/disable flag about whether to transmit an acknowledge signal after continuous reception, thus controlling reception operation.

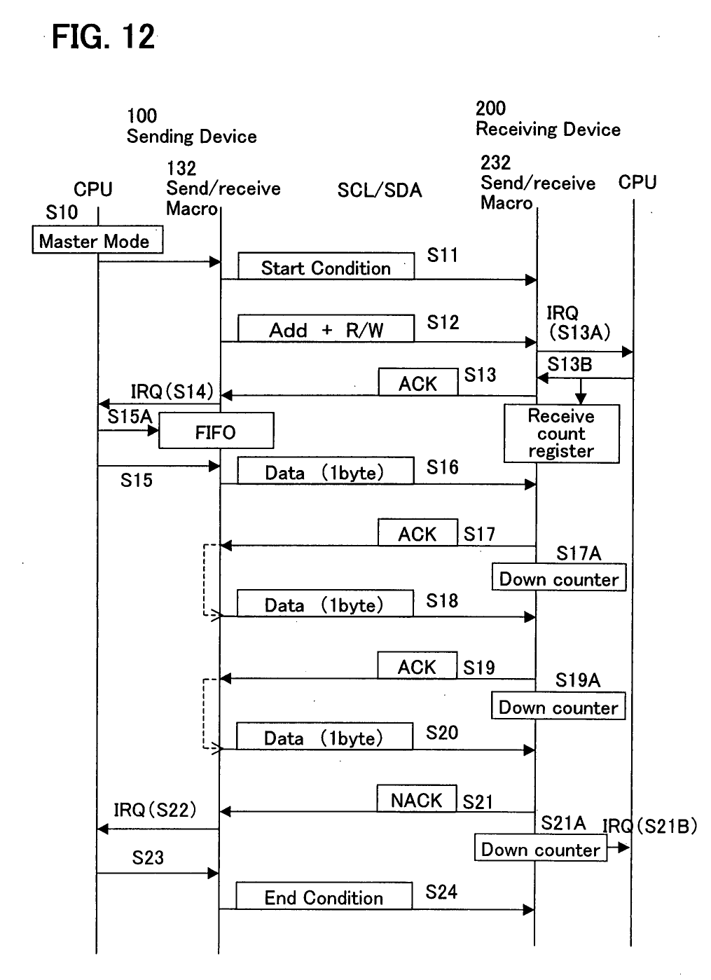

FIG. 12 illustrates a sequence chart of the present embodiment. The same reference numbers are assigned to the steps identical to those in FIG. 9. This example shows a case in which the receiving device 200 terminates data transfer after receiving three bytes of data.

After the sending device 100 moves into master mode (S10) and the send/receive macro 132 drives the bus to start condition (S11), followed by serial transfer of an address (S12), the receiving send/receive macro 232 recognizes the received address as its own and generates an interrupt to the CPU (S13A). The CPU sets a receivable byte count in the receive count register (S13B), causing the send/receive macro 232 to output an address acknowledge signal (S13).

The send/receive macro 132 of the sending device detects the address acknowledge signal, generating an interrupt to the CPU (S14). In response thereto, the CPU writes transfer data to the FIFO (S15A) and instructs the data send/receive unit 48 to initiate data transfer (S15). When one-byte data is transferred (S16), the data send/receive unit of the receiving send/receive macro 232 outputs the receive completion signal S481 and the ACK generation unit outputs a data acknowledge signal (S17), with the setting counted down concurrently by the downcounter (S17A). Similar data transfer, return of data acknowledge signal and downcounting (S18, S19, S19A) take place, and after the last data transfer (S20), the receiving send/receive macro 232 does not return any data acknowledge signal (S21). Upon detection thereof, the sending send/receive macro 132 generates an interrupt to the CPU (S22). When downcounting is performed (S21A), the receive control unit 56 in the receiving send/receive macro 232 generates an interrupt IRQ to the CPU (S21B), notifying the CPU that the reception of as much data as the initially set byte count is complete. Finally, in response to the instruction from the CPU (S23), the send/receive macro 132 drives the bus to stop condition (S24).

Thus, when acting as receiver, the send/receive macro is similarly capable of offering more data transfer volumes by returning a data acknowledge signal after one-byte data reception, without giving any load to the CPU. The CPU sets a receivable byte count at first, and the send/receive macro generates a receive completion interrupt to the CPU at the completion of transfer of as much data as the set receivable count to prevent return of data acknowledge signal, thus avoiding overflow of the receiving device with received data and permitting the CPU to control the receivable byte count at a time. In other words, the CPU does not need to enable or disable the data acknowledge signal generation enable/disable flag based on a predetermined judgment as a result of an interrupt generated on each reception of one-byte data as has been previously done. Instead, the CPU can have the reception of multi-byte data carried out with no interrupts and can control, at the completion of the reception, whether or not to transmit data acknowledge signal, thus reducing the frequency of CPU control. As for hardware configuration required for that purpose in the send/receive macro, it is enough to provide the receive control unit 56 shown in FIG. 11.

### Fourth Embodiment

In the present embodiment, a send/receive buffer constituted by FIFO is provided in the send/receive macro so that the multi-byte data transfer is carried out without generating any interrupt to the CPU. In connection therewith, CPU access to the send/receive buffer is prohibited during the data phase period in which data transfer takes place. Disabling CPU access to the FIFO during the data phase period simplifies the configuration of access to the FIFO by the data send/receive unit 48 in the send/receive macro. For instance, the FIFO can be constituted by single-port RAM.

The aforementioned inhibited CPU access to the FIFO is observed by the software run by the CPU. However, in the presence of some type of bug arising from the software development steps, the inhibited access specification may be violated, resulting in improper CPU access to the FIFO during the data transfer. Such an improper access is expected to lead to data transfer error during the data phase period or put the system into an unpredictable state.

In the fourth embodiment, for this reason, the capability that allows detection of the improper access is provided in the send/receive macro. As shown in FIG. 3, the send/receive macro 32 has the transfer-in-progress flag 58 for indicating the data phase period and an error flag 60 for recording occurrences of the improper access.

The operation of the flags 58 and 60 will be described with reference to the sequence chart shown in FIG. 9. In case of transmission, a transfer-in-progress flag is written to the transfer-in-progress flag 58 when the CPU finishes writing the transmitting data to the FIFO, and a transfer complete flag is written to the flag 58 in response to the fact that an empty flag in the FIFO becomes empty. In case of reception, a transfer-in-progress flag is written to the transfer-in-progress flag 58 when the CPU writes a receivable count to the receivable count register 561, and a transfer complete flag is written to the flag 58 at the completion of reception when the count value of the downcounter 562 reaches zero. The transfer-in-progress flag 58 is supplied with the data send/receive start signal S482 from the data send/receive unit 48. Therefore, the transfer-in-progress flag 58 stores a flag indicating that data transfer is in progress between the steps S16 and S24. The data transfer period includes the period during which the send/receive macro transmits data as the sending device and that the period during which the send/receive macro receives data as the receiving device. When the transfer-in-progress flag 58 is in transfer complete state, that is, when an interrupt is generated to the CPU, CPU access is permitted to the FIFO.

When accessed by the CPU, the FIFO 46 that serves as send/receive buffer detects a send/receive buffer address supplied via the low-speed bus 28. For this reason, the FIFO 46 incorporates a decoder DEC. The FIFO 46 recognizes the supplied address as its own, receiving access from the CPU. Therefore, if the transfer-in-progress flag 58 stores a flag indicating that data transfer is in progress and if the FIFO 46 detects an access from the CPU, the FIFO 46 stores in the error flag 58 a flag indicating that an improper access has occurred. The error flag 60 is read by the CPU, for example, when a debug program is run.

As set forth hereinabove, according to the present embodiment, if an improper access takes place from the CPU to the FIFO during the data transfer period, the occurrence thereof is recorded in the error flag 60. Therefore, it is possible to detect issuance of improper access instruction by the program by checking the content of the error flag 60 in the debug step among the program development steps, thus considerably contributing to the debug step.

1. (canceled)

2. (canceled)

3. (canceled)

4. (canceled)

5. (canceled)

6. An integrated circuit device having a send/receive macro for serially transferring addresses and data to or from an external device via a serial transfer bus,
the integrated circuit device comprising:
a CPU for performing predetermined processing, wherein
the send/receive macro comprises:
a send/receive buffer accessed by the CPU, for storing a plurality of units of data to be transmitted to or received from the serial transfer bus;
a data send unit for transmitting data stored in the send/receive buffer; and
an arbitration lost detection unit for detecting whether or not, during an address phase in which the data send unit, as a master, serially transmits an address identifying a slave device, an arbitration lost has occurred as a result of concurrent transmission of an address from other master and wherein
when the arbitration lost detection unit does not detect occurrence of the arbitration lost during the address phase, the CPU stores data to be transferred in the send/receive buffer after the address phase.

7. The integrated circuit device according to claim 6, wherein
if the arbitration lost detection unit detects occurrence of the arbitration lost during the address phase, the CPU does not store the data to be transferred in the send/receive buffer.

8. An integrated circuit device having a send/receive macro for serially transferring addresses and data to or from an external device via a serial transfer bus,
the integrated circuit device comprising:
a CPU for performing predetermined processing, wherein
the send/receive macro comprises:
a send/receive buffer accessed by the CPU, for storing a plurality of units of data to be transmitted to or received from the serial transfer bus;
a data receive unit for receiving data transmitted via the serial transfer bus and storing the received data in the send/receive buffer; and
an acknowledge signal generation unit for transmitting a data acknowledge signal to a sending device in response to reception of the predetermined units of data, and wherein
the acknowledge signal generation unit transmits the data acknowledge signal on each reception of the predetermined units of data until reaching to a receivable data unit count without generating any interrupt to the CPU, and the acknowledge signal generation unit stops transmission of the data acknowledge signal when reaching to the receivable data unit count.

9. The integrated circuit device according to claim 8, further comprising:
a receive control unit having a receivable count register for storing the receivable data unit count and a counter for counting the receive count each time the data receive unit receives the predetermined units of data, wherein
the acknowledge signal generation unit stops transmitting the data acknowledge signal in response to the count value of the counter reaching the receivable data unit count stored in the receivable count register.

10. The integrated circuit apparatus according to claim 9, wherein
the CPU sets the receivable data unit count in the receivable count register.

11. The integrated circuit apparatus according to claim 9, wherein
the receive control unit generates an interrupt to the CPU in response to the count value of the counter reaching the receivable data unit count.

12. An integrated circuit device having a send/receive macro for serially transferring addresses and data to or from an external device via a serial transfer bus,
the integrated circuit device comprising:
a CPU for performing predetermined processing, wherein
the send/receive macro comprises:
a send/receive buffer accessed by the CPU, for storing a plurality of units of data to be transmitted to or received from the serial transfer bus;
a data send/receive unit for receiving data transmitted via the serial transfer bus and storing the received data in the send/receive buffer, and for transmitting the data stored in the send/receive buffer; and
an access flag register for storing, in the event of an access from the CPU to the send/receive buffer during transmission and reception of the transferring data by the data send/receive unit, a flag indicating occurrence of the access.

13. The integrated circuit device according to claim 12, wherein
the send/receive macro further comprises:
an acknowledge signal detection unit for detecting a data acknowledge signal transmitted from a receiving device in response to transmission of the predetermined units of data, and wherein
the data send/receive unit transmits data stored in the send/receive buffer, without generating any interrupt to the CPU, in response to detection of the data acknowledge signal by the acknowledge signal detection unit.

14. The integrated circuit device according to claim 12, wherein
the send/receive macro further comprises
an acknowledge signal generation unit for transmitting a data acknowledge signal to a sending device in response to reception of the predetermined units of data, and wherein
the acknowledge signal generation unit transmits the data acknowledge signal, without generating any interrupt to the CPU, in response to reception of the predetermined units of data, until reaching a receivable data unit count, the acknowledge signal generation unit stops transmission of the data acknowledge signal when reaching to the receivable data unit count.
